(19) United States
(12) Patent Application Publication
(10) Pub. No.: US 2025/0373684 A1
(43) Pub. Date: Dec. 4, 2025

(54) LOAD BALANCING METHOD AND SYSTEM FOR PROVIDING ARTIFICIAL INTELLIGENCE SERVICE

(71) Applicant: REBELLIONS INC., Seongnam-si (KR)

(72) Inventors: Gijeong KIM, Seongnam-si (KR); Haejoon KIM, Seongnam-si (KR); Heesu SUNG, Seongnam-si (KR)

(21) Appl. No.: 19/021,028

(22) Filed: Jan. 14, 2025

(30) Foreign Application Priority Data
Jun. 3, 2024 (KR) 10-2024-0072637

(51) Int. Cl. H04L 67/1014; H04L 67/1008; H04L 67/1017

(52) U.S. Cl. CPC H04L 67/1014; H04L 67/1008; H04L 67/1017

(57) ABSTRACT

A load balancing method in an Artificial Intelligence (AI) service providing system, comprising: obtaining load balancing information of a plurality of servers, generating a load balancing table based on the load balancing information of the plurality of servers, obtaining an inference task request message for an AI service from a user device, deriving at least one target server among the plurality of servers based on the inference task message for the AI service and the load balancing table, and performing load balancing for an inference task of the AI service on the derived target server based on a preset load balancing algorithm, wherein the load balancing information includes connection information, AI model information, and supported hardware information of each server.

### CROSS REFERENCE TO RELATED APPLICATION

The present application claims priority to Korean Patent Application No. 10-2024-0072637, filed on Jun. 3, 2024, the entire contents of which is incorporated herein for all purposes by this reference.

### TECHNICAL FIELD

The present disclosure relates to a load balancing method and system using a load balancing table in an AI service providing system.

### BACKGROUND

With the development of Artificial Intelligence (AI) technology, AI services utilizing it are becoming more widespread, and data centers including multiple backend servers are being built to provide AI services.

In addition, AI models and hardware that provide various AI services are being developed, and multiple backend servers built in data centers may also support various AI models and include various supported hardware.

However, conventional load balancing methods may cause the load balancing task to become complex and difficult for data centers built with servers that support various AI models and include large-scale supported hardware.

Accordingly, there is a growing need for a load balancing method or system that distributes inference tasks for AI services in data centers built with servers including various AI models and various types of hardware.

### SUMMARY

An object of the present disclosure is to provide a load balancing method and AI service providing system that considers AI support information of a server by using a load balancing table to solve the above problems.

In order to achieve the object, a load balancing method according to an embodiment of the present disclosure includes: obtaining load balancing information of a plurality of servers, generating a load balancing table based on the load balancing information of the plurality of servers, obtaining an inference task request message for an AI service from a user device, deriving at least one target server among the plurality of servers based on the inference task request message for the AI service and the load balancing table, and performing load balancing for an inference task of the AI service on the derived target server based on a preset load balancing algorithm, wherein the load balancing information includes connection information, AI model information, and supported hardware information of each server.

According to another embodiment of the present disclosure, an AI service providing system includes a data center including a load balancing device and a plurality of servers, and a user device connected to the data center via a network, wherein each server of the plurality of servers generates load balancing information and transmits the load balancing information to the load balancing device, the load balancing device generates a load balancing table based on the load balancing information, obtains an inference task request message for an AI service from the user device, derives at least one target server among the plurality of servers based on the inference task request message for the AI service and the load balancing table, performs load balancing for an inference task of the AI service on the derived target server based on a preset load balancing algorithm, and transmits an inference task result transmitted from the target server to which the inference task is distributed to the user device, and wherein the load balancing information includes connection information, AI model information, and supported hardware information of each server.

According to an embodiment of the present disclosure, load balancing of AI service inference tasks for multiple servers supporting various AI models and including various supported hardware may be performed by considering the supported AI models and/or supported hardware, thereby improving the efficiency of load balancing tasks and reducing management complexity.

According to an embodiment of the present disclosure, a load balancing table including information about AI models, AI model versions, supported hardware and endpoints supported by multiple servers may be generated, and load balancing considering the supported AI models and/or supported hardware may be performed based on the generated load balancing table, thereby improving the efficiency of load balancing tasks and reducing its complexity.

According to an embodiment of the present disclosure, load balancing information may be periodically received from servers and a load balancing table used for load balancing may be automatically updated, thereby reducing management complexity of servers in a complex data center.

### BRIEF DESCRIPTION OF THE DRAWINGS

FIG. 1 is a block diagram illustrating an embodiment of an AI service providing system using a data center including a plurality of servers according to an embodiment of the present disclosure.

FIG. 2 is a diagram provided to explain load balancing algorithms in detail.

FIG. 3 is a block diagram illustrating an embodiment of an AI service providing system using a data center including servers including various AI models and supported hardware according to an embodiment of the present disclosure.

FIG. 4 is a diagram illustrating load balancing information generated by servers in a data center.

FIG. 5 is a flowchart for explaining in detail a load balancing method considering a supported AI model and/or hardware of a server in an AI service providing system using a data center composed of a plurality of servers according to an embodiment of the present disclosure.

FIG. 6 is a diagram for explaining in detail an embodiment of load balancing an inference task of an AI service using a load balancing table according to the present disclosure.

FIG. 7 is a diagram for explaining in detail another embodiment of load balancing an inference task of an AI service using a load balancing table according to the present disclosure.

FIG. 8 is a diagram for explaining in detail another embodiment of load balancing an inference task of an AI service using a load balancing table according to the present disclosure.

FIG. 9 is a diagram for explaining in detail another embodiment of load balancing an inference task of an AI service using a load balancing table according to the present disclosure.

FIG. 10 is a diagram for explaining in detail another embodiment of load balancing an inference task of an AI service using a load balancing table according to the present disclosure.

FIG. 11 is a diagram for explaining in detail another embodiment of load balancing an inference task of an AI service using a load balancing table according to the present disclosure.

FIG. 12 is a diagram for explaining in detail another embodiment of load balancing an inference task of an AI service using a load balancing table according to the present disclosure.

FIG. 13 is a diagram for explaining in detail another embodiment of load balancing an inference task of an AI service using a load balancing table according to the present disclosure.

FIG. 14 is a diagram for explaining in detail another embodiment of load balancing an inference task of an AI service using a load balancing table according to the present disclosure.

FIG. 15 is a diagram for explaining in detail another embodiment of load balancing an inference task of an AI service using a load balancing table according to the present disclosure.

FIG. 16 is a diagram for explaining in detail another embodiment of load balancing an inference task of an AI service using a load balancing table according to the present disclosure.

FIG. 17 is a flowchart for explaining in detail a load balancing method using a load balancing table in an AI service providing system according to an embodiment of the present disclosure.

### DETAILED DESCRIPTION

Hereinafter, example details for the practice of the present disclosure will be described in detail with reference to the accompanying drawings. However, in the following description, detailed descriptions of well-known functions or configurations will be omitted if it may make the subject matter of the present disclosure rather unclear.

In the accompanying drawings, the same or corresponding components are assigned the same reference numerals. In addition, in the following description of various examples, duplicate descriptions of the same or corresponding components may be omitted. However, even if descriptions of components are omitted, it is not intended that such components are not included in any example.

Advantages and features of the disclosed examples and methods of accomplishing the same will be apparent by referring to examples described below in connection with the accompanying drawings. However, the present disclosure is not limited to the examples disclosed below, and may be implemented in various forms different from each other, and the examples are merely provided to make the present disclosure complete, and to fully disclose the scope of the disclosure to those skilled in the art to which the present disclosure pertains.

The terms used herein will be briefly described prior to describing the disclosed example(s) in detail. The terms used herein have been selected as general terms which are widely used at present in consideration of the functions of the present disclosure, and this may be altered according to the intent of an operator skilled in the art, related practice, or introduction of new technology. In addition, in specific cases, certain terms may be arbitrarily selected by the applicant, and the meaning of the terms will be described in detail in a corresponding description of the example(s). Therefore, the terms used in the present disclosure should be defined based on the meaning of the terms and the overall content of the present disclosure rather than a simple name of each of the terms.

As used herein, the singular forms “a,” “an,” and “the” are intended to include the plural forms as well, unless the context clearly indicates the singular forms. Further, the plural forms are intended to include the singular forms as well, unless the context clearly indicates the plural forms. Further, throughout the description, when a portion is stated as “comprising (including)” a component, it is intended as meaning that the portion may additionally comprise (or include or have) another component, rather than excluding the same, unless specified to the contrary.

Further, the term “module” or “unit” used herein refers to a software or hardware component, and “module” or “unit” performs certain roles. However, the meaning of the “module” or “unit” is not limited to software or hardware. The “module” or “unit” may be configured to be in an addressable storage medium or configured to play one or more processors. Accordingly, as an example, the “module” or “unit” may include components such as software components, object-oriented software components, class components, and task components, and at least one of processes, functions, attributes, procedures, subroutines, program code segments, drivers, firmware, micro-codes, circuits, data, database, data structures, tables, arrays, and variables. Furthermore, functions provided in the components and the “modules” or “units” may be combined into a smaller number of components and “modules” or “units”, or further divided into additional components and “modules” or “units.”

A “module” or “unit” may be implemented as a processor and a memory, or may be implemented as a circuit (circuitry). Terms such as “circuit (circuitry)” may refer to a circuit in hardware, but may also refer to a circuit in software. The “processor” should be interpreted broadly to encompass a general-purpose processor, a Central Processing Unit (CPU), a microprocessor, a Digital Signal Processor (DSP), a controller, a microcontroller, a state machine, and so forth. Under some circumstances, “processor” may refer to an application-specific integrated circuit (ASIC), a programmable logic device (PLD), or a field-programmable gate array (FPGA), and so on. The “processor” may refer to a combination for processing devices, e.g., a combination of a DSP and a microprocessor, a combination of a plurality of microprocessors, a combination of one or more microprocessors in conjunction with a DSP core, or any other combination of such configurations. In addition, the “memory” should be interpreted broadly to encompass any electronic component that is capable of storing electronic information. The “memory” may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or marking data storage, registers, and so on. The memory is said to be in electronic communication with a processor if the processor can read information from and/or write information to the memory. The memory integrated with the processor is in electronic communication with the processor.

In the present disclosure, “each of a plurality of A” may refer to each of all components included in the plurality of A, or may refer to each of some of the components included in a plurality of A.

In addition, terms such as first, second, A, B, (a), (b), etc. used in the following examples are only used to distinguish certain components from other components, and the nature, sequence, order, etc. of the components are not limited by the terms.

In addition, in the following examples, if a certain component is stated as being “connected,” “combined” or “coupled” to another component, it is to be understood that there may be yet another intervening component “connected,” “combined” or “coupled” between the two components, although the two components may also be directly connected or coupled to each other.

In addition, as used in the following examples, “comprise” and/or “comprising” does not foreclose the presence or addition of one or more other elements, steps, operations, and/or devices in addition to the recited elements, steps, operations, or devices.

In addition, in the following examples, “determining whether it is less than” or “if it is less than” are disclosed, but “determining whether it is less than or equal to” or “if it is less than or equal to” may also be applied to the examples.

Before describing various examples of the present disclosure, terms used herein will be explained.

In the present disclosure, “instruction” may refer to a series of computer-readable commands grouped based on function, which are components of a computer program and executed by a processor.

In the present disclosure, “network” may be implemented as a wired network such as a Local Area Network (LAN), a Wide Area Network (WAN), or a Value Added Network (VAN), or any type of wireless network such as a mobile radio communication network or a satellite communication network.

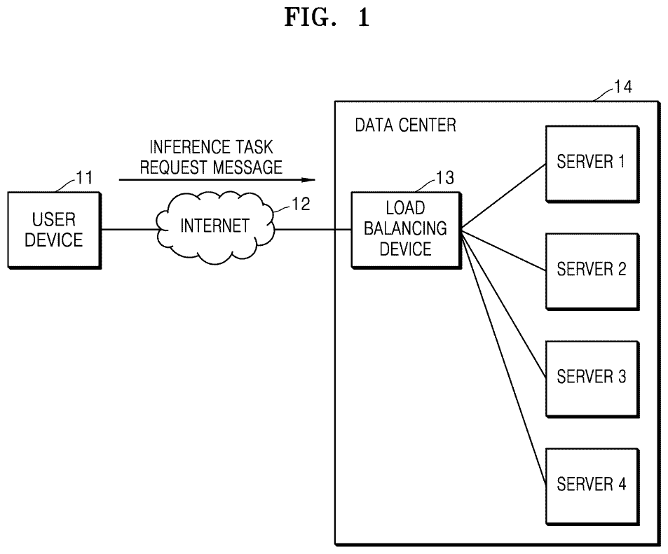

FIG. 1 is a block diagram illustrating an embodiment of an AI service providing system using a data center including a plurality of servers according to an embodiment of the present disclosure. Referring to FIG. 1, the AI service providing system may include a user device (11), an Internet (12), and/or a data center (14). The data center may include a load balancing device (13) and at least one server. Although FIG. 1 illustrates the data center as including four servers, it is not limited thereto and may be configured to include a different or greater number of servers. The server of the data center (14) may include an AI accelerator including a neural processing unit (NPU) that performs calculations using an artificial neural network to provide Artificial Intelligence (AI) services. The server may be called a backend server.

Referring to FIG. 1, the user device (11) may be connected to the load balancing device (13) via a network such as the Internet (12). The load balancing device (13) may be a load balancer or an API gateway. The user device (11) may request an inference task for an AI service to the load balancing device (13) via the Internet. That is, for example, the user device (11) may transmit an inference task request message for the AI service to the load balancing device (13). For example, the inference task request message may be in URL format. The URL format may consist of a protocol identifier, a host address path, and/or a query.

The load balancing device (13) may perform load balancing for the inference task for the AI service to the servers. That is, the load balancing device (13) may distribute the inference task for the AI service to the servers. For example, the load balancing may perform load balancing based on a preset load balancing algorithm. For example, the preset load balancing algorithm may be a round robin algorithm, a sticky round robin algorithm, a weighted round robin algorithm, an IP/URL hash algorithm, a least connection algorithm, or a least time algorithm.

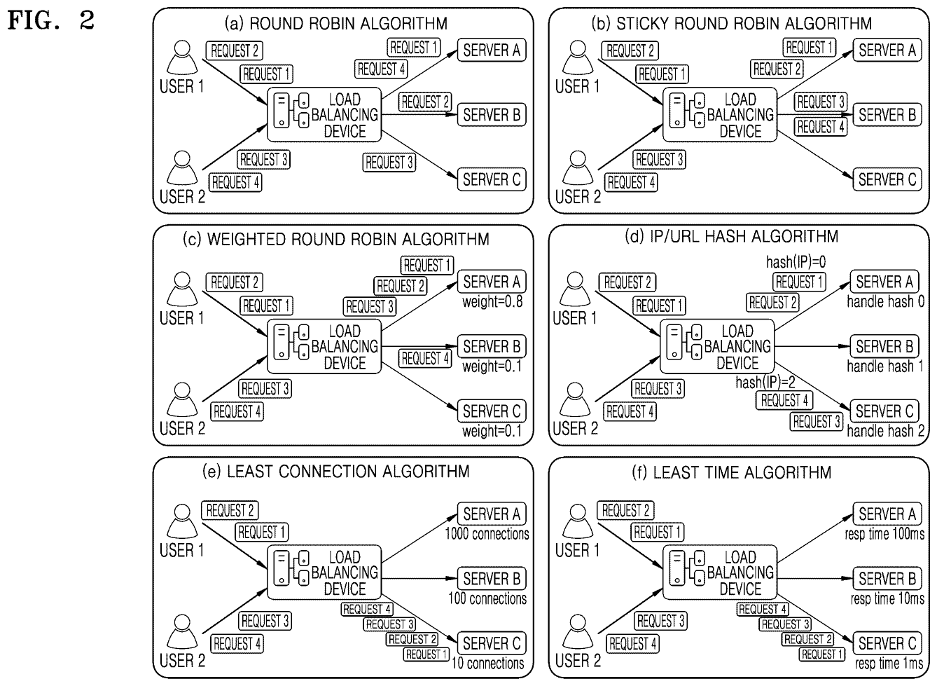

FIG. 2 is a diagram provided to explain load balancing algorithms in detail. Referring to FIG. 2, the load balancing device may perform load balancing according to a load balancing algorithm.

For example, (a) of FIG. 2 represents a round robin algorithm. The round robin algorithm may be a method of distributing requests transmitted to a load balancing device to servers in the order in which they are requested. For example, referring to (a) of FIG. 2, the load balancing device may distribute requests 1 to 4 transmitted from user 1 and user 2 to server A, server B, and server C in that order.

Also, for example, (b) of FIG. 2 represents a sticky round robin algorithm. The sticky round robin algorithm may be a method of distributing requests transmitted to a load balancing device to servers in the order in which they are request, but when a request of a specific user is distributed to a specific server, the next request of the specific user is also distributed to the specific server. For example, referring to (b) of FIG. 2, the load balancing device may distribute requests 1 to 2 transmitted from user 1 to server A, and may distribute requests 3 to 4 transmitted from user 2 to server B.

Also, for example, (c) of FIG. 2 represents a weighted round robin algorithm. The weighted round robin algorithm may be a method of distributing requests transmitted to a load balancing device to servers in order, but distributing the requests according to weights. Specifically, when the weighted round robin algorithm is applied, it may be a method of preferentially distributing requests to a server with high weight. The load balancing device may preferentially distribute requests to a server with high weight, but may distribute up to a number of requests to the server equal to a ratio of the weight in the total number of requests (for example, 4*0.8=3.2). For example, referring to (c) of FIG. 2, a weight of server A may be set to 0.8, a weight of server B may be set to 0.1, and a weight of server C may be set to 0.1, and the load balancing device may distribute three requests including requests 1 to 3 among requests 1 to 4 transmitted from user 1 and user 2 to server A, and may distribute one request including request 4 to server B.

Also, for example, (d) of FIG. 2 represents an IP/URL hash algorithm. The IP/URL hash algorithm may be a method of distributing requests transmitted to a load balancing device based on a hash value for the user's IP/URL. For example, referring to (d) of FIG. 2, a hash value processed by server A may be set to 0, a hash value processed by server B may be set to 1, and a hash value processed by server C may be set to 2, and a hash value for IP/URL of user 1 may be derived as 0, and a hash value for the IP/URL of user 2 may be derived as 2. In this case, the load balancing device may distribute requests 1 to 2 transmitted from user 1 to server A, and distribute requests 3 to 4 transmitted from user 2 to server C.

Also, for example, (e) of FIG. 2 represents a least connections algorithm. The least connection algorithm may be a method of distributing requests transmitted to a load balancing device to a server with the least connections among servers. For example, referring to (e) of FIG. 2, the number of connections of server A may be 1000, the number of connections of server B may be 100, and the number of connections of server C may be 10. In this case, the load balancing device may distribute requests 1 to 4 transmitted from user 1 and user 2 to server C, which has the least connections.

Also, for example, (f) of FIG. 2 represents a least time algorithm. The least time algorithm may be a method of distributing requests transmitted to a load balancing device to a server with the least response time among servers. For example, referring to (f) of FIG. 2, a response time of server A may be 100 ms, a response time of server B may be 10 ms, a response time of server C may be 1 ms. In this case, the load balancing device may distribute requests 1 to 4 transmitted from user 1 and user 2 to server C with the least response time.

Meanwhile, the diversity of AI models for AI services and hardware supporting AI services is continuously increasing, and thus, data centers that include large-scale servers including AI accelerators may be built. Therefore, in a data center built with servers including various hardware and large-scale AI accelerators, performing load balancing using conventional load balancing methods that utilize URL information, IP information, TCP/UDP port information, etc. may be complex and difficult.

In order to solve the problem, the present document proposes a method for performing load balancing by considering AI model information and hardware information supported by a server in a data center supporting AI services. As an example, a method for performing load balancing according to an embodiment of the present document may be proposed as follows.

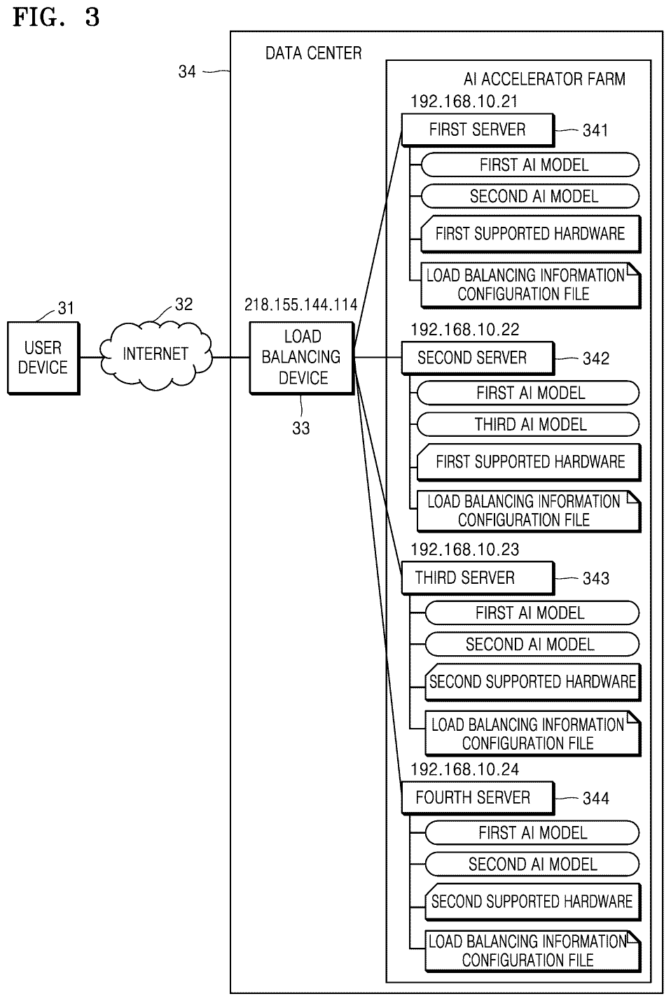

FIG. 3 is a block diagram illustrating an embodiment of an AI service providing system using a data center including servers including various AI models and supported hardware according to an embodiment of the present disclosure.

Referring to FIG. 3, an AI service providing system may include a user device (31) and/or a data center (34). The user device (31) may be connected to the data center via a network such as the Internet. The data center may a load balancing device (33) and at least one server. Although FIG. 3 illustrates that the data center as including four servers, it is not limited thereto and may be configured to include a different or greater number of servers. In addition, AI models and hardware supported by the servers included in the data center may be different. In addition, even if the servers support the same AI model, supported AI model versions may be different. AI models providing various AI services may be supported, and the supported hardware of the servers may include various types of AI accelerators from various manufacturers.

For example, referring to FIG. 3, an AI model supported by a first server (341) of the data center (34) may be a first AI model, and supported hardware of the first server may be a first supported hardware. In addition, AI models supported by a second server (342) of the data center (34) may be a first AI model and a third AI model, and supported hardware of the second server may be a first supported hardware. In addition, AI models supported by a third server (343) of the data center (34) may be a first AI model and a second AI model, and supported hardware of the third server may be a second supported hardware. The first supported hardware and the second supported hardware may be AI accelerators from different manufacturers and/or of different types. In addition, AI models supported by a fourth server (344) of the data center (34) may be a first AI model and a second AI model, and supported hardware of the fourth server may be a second supported hardware.

As described above, AI model information and hardware information supported by the servers in the data center may be different. Accordingly, in order to perform load balancing by considering the AI model information and hardware information supported by the servers in the data center, the servers in the data center may generate load balancing information and transmit the load balancing information to the load balancing device.

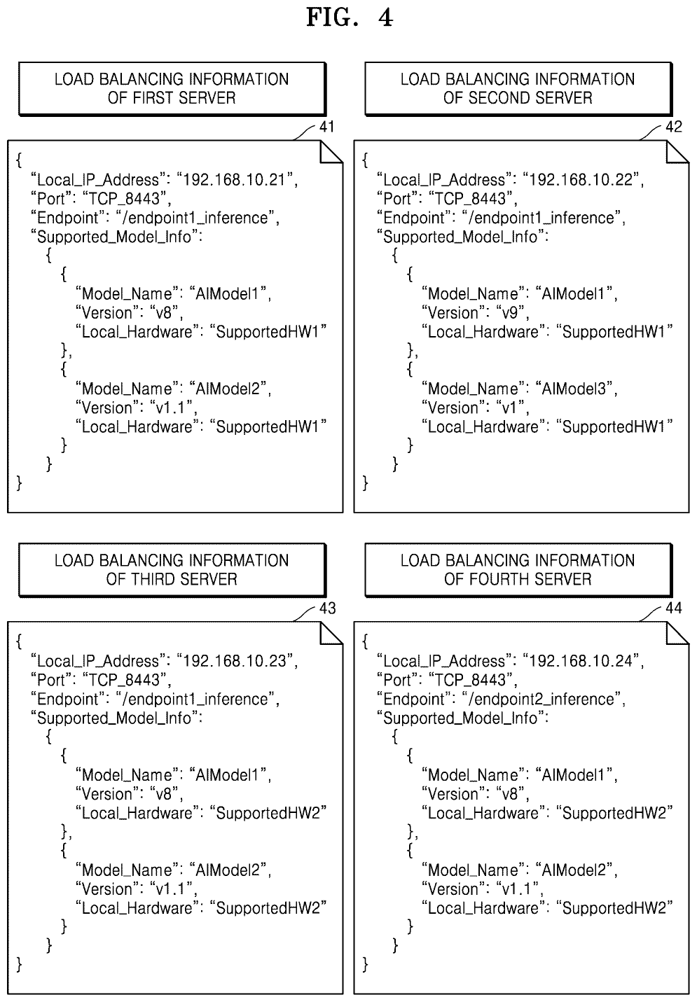

FIG. 4 is a diagram illustrating load balancing information generated by servers in a data center. As illustrated in FIG. 4, load balancing information (41) of a first server (341) of a data center (34), load balancing information (42) of a second server (342), load balancing information (43) of a third server (343), and load balancing information (44) of a fourth server (344) may be generated. That is, for example, the first server (341) may generate the load balancing information (41) of the first server (341), the second server (342) may generate the load balancing information (42) of the second server (342), the third server (343) may generate the load balancing information (43) of the third server (343), and the fourth server (344) may generate the load balancing information (44) of the fourth server (344). The load balancing information may be generated in the form of a configuration file.

For example, load balancing information of a server may include connection information, AI model information, and/or supported hardware information supported by the server. The connection information may represent a local IP address, a port, and/or an endpoint of the server, the AI model information may represent an AI model name and/or an AI model version, and the supported hardware information may represent local hardware of the server.

For example, the load balancing information (41) of the first server (341) may include connection information, AI model information, and/or supported hardware information of the first server (341). For example, the connection information included in the load balancing information (41) may represent that a local IP address of the first server (341) is “192.168.10.21”, a port of the first server (341) is “TCP_8443”, and an endpoint supported by the first server (341) is “/endpoint1_inference”. In addition, for example, the AI model information included in the load balancing information (41) may represent that an AI model name supported by the first server (341) is “AIModel1”, and a version of “AIModel1” supported by the first server (341) is “v8”. In addition, for example, the supported hardware information included in the load balancing information (41) may represent that a local hardware supporting the “AIModel1” in the first server (341) is “SupportedHW1”.

In addition, for example, the load balancing information (42) of the second server (342) may include connection information, AI model information, and/or supported hardware information of the second server (342). For example, the connection information included in the load balancing information (42) may represent that a local IP address of the second server (342) is “192.168.10.22”, a port of the second server (342) is “TCP_8443”, and an endpoint supported by the second server (342) is “/endpoint1_inference”. In addition, for example, the AI model information included in the load balancing information (42) may represent that an AI model name supported by the second server (342) is “AIModel1” and a version of “AIModel1” supported by the second server (342) is “v9”. In addition, for example, the supported hardware information included in the load balancing information (42) may represent that a local hardware supporting the “AIModel1” in the second server (342) is “SupportedHW1”. In addition, for example, the AI model information included in the load balancing information (42) may represent that an AI model name supported by the second server (342) is “AIModel3” and a version of “AIModel3” supported by the second server (342) is “v1”. In addition, for example, the supported hardware information included in the load balancing information (42) may represent that a local hardware supporting “AIModel3” in the second server (342) is “SupportedHW1”.

In addition, for example, the load balancing information (43) of the third server (343) may include connection information, AI model information, and/or supported hardware information of the third server (343). For example, the connection information included in the load balancing information (43) may represent that a local IP address of the third server (343) is “192.168.10.23”, a port of the third server (343) is “TCP_8443”, and an endpoint supported by the third server (343) is “/endpoint1_inference”. In addition, for example, the AI model information included in the load balancing information (43) may represent that an AI model name supported by the third server (343) is “AIModel1” and a version of “AIModel1” supported by the third server (343) is “v8”. In addition, for example, the supported hardware information included in the load balancing information (43) may represent that a local hardware supporting “AIModel1” in the third server (343) is “SupportedHW2”. In addition, for example, the AI model information included in the load balancing information (43) may represent that an AI model name supported by the third server (343) is “AIModel2” and a version of “AIModel2” supported by the third server (343) is “v1.1”. In addition, for example, the supported hardware information included in the load balancing information (43) may represent that a local hardware supporting “AIModel2” in the third server (343) is “SupportedHW2”.

In addition, for example, the load balancing information (44) of the fourth server (344) may include connection information, AI model information, and/or supported hardware information of the fourth server (344). For example, the connection information included in the load balancing information (44) may represent that a local IP address of the fourth server (344) is “192.168.10.24”, a port of the fourth server (344) is “TCP_8443”, and an endpoint supported by the fourth server (344) is “/endpoint2_inference”. In addition, for example, the AI model information included in the load balancing information (44) may represent that an AI model name supported by the fourth server (344) is “AIModel1” and a version of “AIModel1” supported by the fourth server (344) is “v8”. In addition, for example, the supported hardware information included in the load balancing information (44) may represent that a local hardware supporting “AIModel1” in the fourth server (344) is “SupportedHW2”. In addition, for example, the AI model information included in the load balancing information (44) may represent that an AI model name supported by the fourth server (344) is “AIModel2” and a version of “AIModel2” supported by the fourth server (344) is “v1.1”. In addition, for example, the supported hardware information included in the load balancing information (44) may represent that a local hardware supporting “AIModel2” in the fourth server (344) is “SupportedHW2”.

As described above, the servers of the data center may generate load balancing information and transmit the load balancing information to a load balancing device. The load balancing device may generate a load balancing table based on the load balancing information of the servers. For example, the load balancing table may include load balancing information for an inference task of an AI service, and the load balancing information may include service information, connection information supported by a server, AI model information supported by the server, and/or supported hardware information of the server.

For example, a load balancing device may generate an initial load balancing table.

An example of the initial load balancing table may be as follows. Meanwhile, the table described below is only an example of the initial load balancing table and is not limited thereto.

TABLE 1

| | Service | | Server | Server | | AI | AI | |
|---|---|---|---|---|---|---|---|---|
| Service IP | port | | IP | port | | model | model | Supported |
| address | number | Base URL | address | number | Endpoint | name | version | hardware |
| 218.155.144.114 | 443 | rebellions/ai | — | — | — | — | — | — |
| 218.155.144.114 | 443 | rebellions/ai | — | — | — | — | — | — |
| 218.155.144.114 | 443 | rebellions/ai | — | — | — | — | — | — |
| 218.155.144.114 | 443 | rebellions/ai | — | — | — | — | — | — |
| 218.155.144.114 | 443 | rebellions/ai | — | — | — | — | — | — |
| 218.155.144.114 | 443 | rebellions/ai | — | — | — | — | — | — |
| 218.155.144.114 | 443 | rebellions/ai | — | — | — | — | — | — |
| 218.155.144.114 | 443 | rebellions/ai | — | — | — | — | — | — |

For example, referring to Table 1, the initial load balancing table may include load balancing information for an inference task of an AI service. The initial load balancing information may include service information. For example, the first row of the initial load balancing table may represent load balancing information for an inference task of a first AI service. For example, the service information of the load balancing information in the initial load balancing table illustrated in Table 1 may represent that a service IP address is “218.155.144.114”, a service port number is “443”, and a base URL is “rebellions/ai”.

After receiving the load balancing information from the servers, the load balancing device may update the initial load balancing table based on the load balancing information to derive a load balancing table.

An example of the load balancing table may be as follows. Meanwhile, the table described below is only an example of the load balancing table and is not limited thereto.

TABLE 2

| | Service | | Server | Server | | AI | AI | |
|---|---|---|---|---|---|---|---|---|
| Service IP | port | | IP | port | | model | model | Supported |
| address | number | Base URL | address | number | Endpoint | name | version | hardware |
| 218.155.144.114 | 443 | rebellions/ai | 192.168.10.21 | 8443 | /endpoint1_{—} | AIModel1 | v8 | SupportedHW1 |
| | | | | | inference | | | |
| 218.155.144.114 | 443 | rebellions/ai | 192.168.10.21 | 8443 | /endpoint1_{—} | AIModel2 | v1.1 | SupportedHW1 |
| | | | | | inference | | | |
| 218.155.144.114 | 443 | rebellions/ai | 192.168.10.22 | 8443 | /endpoint1_{—} | AIModel1 | v8 | SupportedHW1 |
| | | | | | inference | | | |
| 218.155.144.114 | 443 | rebellions/ai | 192.168.10.22 | 8443 | /endpoint1_{—} | AIModel3 | v1 | SupportedHW1 |
| | | | | | inference | | | |
| 218.155.144.114 | 443 | rebellions/ai | 192.168.10.23 | 8443 | /endpoint1_{—} | AIModel1 | v8 | SupportedHW2 |
| | | | | | inference | | | |
| 218.155.144.114 | 443 | rebellions/ai | 192.168.10.23 | 8443 | /endpoint1_{—} | AIModel2 | v1.1 | SupportedHW2 |
| | | | | | inference | | | |
| 218.155.144.114 | 443 | rebellions/ai | 192.168.10.24 | 8443 | /endpoint2_{—} | AIModel1 | v8 | SupportedHW2 |
| | | | | | inference | | | |
| 218.155.144.114 | 443 | rebellions/ai | 192.168.10.24 | 8443 | /endpoint2_{—} | AIModel2 | v1.1 | SupportedHW2 |
| | | | | | inference | | | |

For example, referring to Table 2, the load balancing table may include load balancing information for an inference task of an AI service. The load balancing information may include service information, connection information supported by a server, AI model information supported by the server, and/or supported hardware information of the server.

For example, the first row of the load balancing table may represent first load balancing information for an inference task of an AI service. The nth row of the load balancing table may represent nth load balancing information for an inference task of an AI service. For example, service information of the first load balancing information of the load balancing table illustrated in Table 2 may represent that a service IP address is “218.155.144.114”, a service port number is 443, and a base URL is “rebellions/ai”. In addition, connection information of the first load balancing information may represent that a server IP address is “192.168.10.21”, a server port number is “8443”, and an endpoint is “/endpoint1_inference”. In addition, AI model information of the first load balancing information may represent that an AI model name is “AIModel1” and an AI model version is “v8”. In addition, supported hardware information of the first load balancing information may represent that supported hardware is “SupportedHW1”.

In addition, for example, the second row of the load balancing table may represent second load balancing information for the inference task of the AI service. For example, service information of the second load balancing information of the load balancing table illustrated in Table 2 may represent that a service IP address is “218.155.144.114”, a service port number is “443”, and a base URL is “rebellions/ai”. In addition, connection information of the second load balancing information may represent that a server IP address is “192.168.10.21”, a server port number is “8443”, and an endpoint is “/endpoint1_inference”. In addition, AI model information of the second load balancing information may represent that an AI model name is “AIModel2” and an AI model version is “v1.1”. In addition, supported hardware information of the second load balancing information may represent that supported hardware is “SupportedHW1”.

The load balancing device may obtain an inference task request message for an AI service from a user device, and derive at least one target server among the servers based on the inference task message for the AI service and the load balancing table.

For example, the inference task request message may include service information, connection information, AI model information, and/or supported hardware information. The load balancing device may derive a target server supporting the service information, connection information, AI model information, and/or supported hardware information included in the inference task request message from the load balancing table. That is, the load balancing device may derive target load balancing information including the same information as the service information, connection information, AI model information, and/or supported hardware information included in the inference task request message from the load balancing table, and may derive a server indicated by the connection information of the derived target load balancing information as the target server.

For example, an inference task request message of a user may be “https://rebellions.ai/endpoint1_inference?model_name=AIModel1”. In this case, the inference task message may include service information, connection information, and AI model information, wherein the service information may represent that a base URL is “rebellions/ai”, the connection information may represent that an endpoint is “endpoint1_inference”, and the AI model information may represent that an AI model name is “AIModel1”. In this case, referring to the load balancing table illustrated in Table 2, the first load balancing information, the third load balancing information, and the fifth load balancing information of the load balancing table include the same information as the inference task message. Accordingly, the load balancing device may derive the first load balancing information, the third load balancing information, and the fifth load balancing information based on the inference task message and the load balancing table, and may derive a first server indicated by the connection information of the first load balancing information, a second server indicated by the connection information of the third load balancing information, and a third server indicated by the connection information of the fifth load balancing information as target servers for the inference task message. Meanwhile, referring to the load balancing table illustrated in Table 2, service information of the seventh load balancing information of the load balancing table represents that a base URL is “rebellions/ai”, and AI model information of the seventh load balancing information represents that an AI model name is “AIModel1”. However, unlike the connection information of the inference task message, connection information of the seventh load balancing information represents that an endpoint is “endpoint2_inference”. Accordingly, since the seventh load balancing information is not load balancing information that includes the same information as the inference task request message, a fourth server indicated by the connection information of the seventh load balancing information may not be derived as a target server.

As another example, an inference task request message of the user may be “https://rebellions.ai/endpoint1_inference?model_name=AImodel1&model_version-v8”. In this case, the inference task message may include service information, connection information, and AI model information, wherein the service information may represent that a base URL is “rebellions/ai”, the connection information may represent that an endpoint is “endpoint1_inference”, and the AI model information may represent that an AI model name is “Almodel1” and that an AI model version is “v8”. In this case, referring to the load balancing table illustrated in Table 2, first load balancing information and fifth load balancing information of the load balancing table include the same information as the inference task message. Accordingly, the load balancing device may derive the first load balancing information and the fifth load balancing information based on the inference task message and the load balancing table, and may derive a first server indicated by connection information of the first load balancing information and a third server indicated by connection information of the fifth load balancing information as target servers for the inference task message.

Thereafter, the load balancing device may perform load balancing for the inference task of the AI service on the derived target server. For example, the load balancing device may perform load balancing for the inference task of the AI service on the derived target server based on a preset load balancing algorithm.

The target server to which the inference task is distributed through the load balancing may perform the inference task and transmit an inference task result of the specific inference task to the load balancing device. The load balancing device may transmit the inference task result to the user device. Thereafter, the user device may provide the user with a result of the AI service requested by the user based on the inference task result.

Meanwhile, AI models and/or hardware supported by servers in the data center may be updated or changed. Accordingly, in order to perform load balancing by reflecting updated load balancing information of the servers, a server in the data center may update load balancing information and transmit the updated load balancing information to the load balancing device. The load balancing device may update the load balancing table based on the updated load balancing information. After the load balancing table is updated, if an inference task request message for an AI service is obtained from a user device, the load balancing device may derive at least one target server among the servers based on the inference task message for the AI service and the updated load balancing table.

In addition, the present disclosure proposes a method for periodically updating and transmitting load balancing information of the server of the data center, and updating the load balancing table. For example, the server of the data center may periodically update load balancing information. For example, the server of the data center may update load balancing information at a specific time interval. The server of the data center may transmit the updated load balancing information to a load balancing device, and the load balancing device may update a load balancing table based on the updated load balancing information. As the data center is constructed with servers including various hardware and large-scale AI accelerators, the scale and complexity of the load balancing task increase, and thus the proposed method may have the effect of reducing the management complexity of the load balancing task by automatically updating the load balancing table periodically.

Meanwhile, the load balancing table may also be updated manually. For example, a server of the data center may be requested to retransmit load balancing information, the server of the data center may transmit the load balancing information to the load balancing device, and the load balancing device may update the load balancing table based on the transmitted load balancing information.

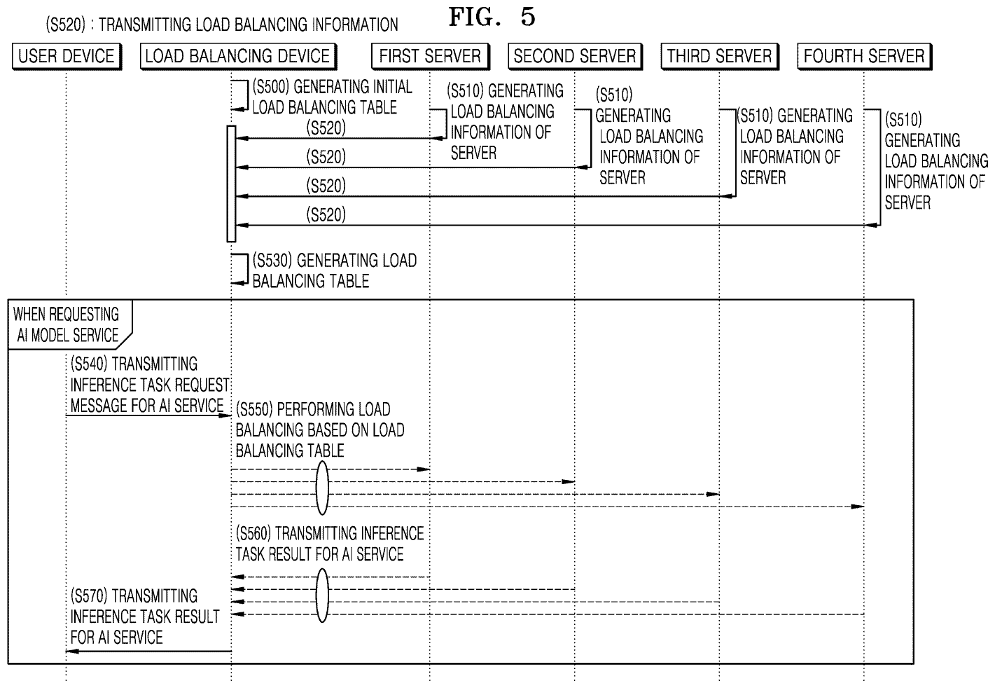

FIG. 5 is a flowchart for explaining in detail a load balancing method considering a supported AI model and/or hardware of a server in an AI service providing system using a data center composed of a plurality of servers according to an embodiment of the present disclosure.

The load balancing device generates an initial load balancing table (S500). For example, the load balancing device may register service information representing a service IP address, a service port number, and/or a base URL in the initial load balancing table. That is, the initial load balancing table may include load balancing information for an inference task of an AI service, and the load balancing information may include service information. For example, the initial load balancing table may be generated as shown in Table 1.

A server of a data center generates load balancing information (S510) and transmits the load balancing information to the load balancing device (S520). For example, the load balancing information may be generated in the form of a load balancing information configuration file.

For example, the data center may include a plurality of servers, and each of the servers may generate load balancing information of each server and transmit the load balancing information of each server to the load balancing device. For example, referring to FIG. 5, a first server may generate load balancing information of the first server and transmit the load balancing information of the first server to the load balancing device. In addition, a second server may generate load balancing information of the second server and transmit the load balancing information of the second server to the load balancing device. In addition, a third server may generate load balancing information of the third server and transmit the load balancing information of the third server to the load balancing device. In addition, a fourth server may generate load balancing information of the fourth server and transmit the load balancing information of the fourth server to the load balancing device. Although FIG. 5 illustrates the data center as including four servers, it is not limited thereto and may be configured to include a different or greater number of servers.

The load balancing device updates the initial load balancing table based on load balancing information transmitted from servers of the data center to generate a load balancing table (S530).

The load balancing table may include load balancing information for the inference task of the AI service. The load balancing information may include service information, connection information supported by the server, AI model information supported by the server, and/or supported hardware information of the server. The load balancing information may include service information, connection information, AI model information supported by the server, and/or supported hardware information of the server.

A user device transmits an inference task request message for an AI service to the load balancing device (S540).

For example, the user device may transmit an inference task request message for an AI service from the device over a network. “network” may be implemented as a wired network such as a Local Area Network (LAN), a Wide Area Network (WAN), or a Value Added Network (VAN), or any type of wireless network such as a mobile radio communication network or a satellite communication network. Also, for example, the user device may transmit input data for the AI service along with the inference task request message to the load balancing device.

The load balancing device performs load balancing based on the inference task request message and the load balancing table (S550).

For example, the load balancing device may derive at least one target server among the servers based on the inference task message for the AI service and the load balancing table, and perform load balancing for the inference task of the AI service on the derived target server.

For example, the load balancing device may derive the target server by referring to the load balancing table. For example, the load balancing device may derive target load balancing information including the same information as the service information, connection information, AI model information, and/or supported hardware information included in the inference task request message from the load balancing table, and may derive a server indicated by the connection information of the derived target load balancing information as the target server. The load balancing device may derive the target server supporting the service information, connection information, AI model information, and/or supported hardware information included in the inference task request message from the load balancing table.

For example, the inference task request message may include AI model information representing a specific AI model name, target load balancing information including AI model information representing the specific AI model name may be derived from the load balancing table, and a server indicated by connection information of the target load balancing information may be derived as the target server. The connection information of the load balancing information may represent a local IP address and a port number of the server.

In addition, for example, the inference task request message may include AI model information representing a specific AI model name and a specific version of the specific AI model, and target load balancing information including AI model information representing the specific AI model name and the specific version of the specific AI model may be derived from the load balancing table, and a server indicated by connection information of the target load balancing information may be derived as the target server. The connection information of the load balancing information may represent a local IP address and a port number of the server.

In addition, for example, the inference task request message may include supported hardware information representing specific hardware, and target load balancing information including supported hardware information representing the specific hardware may be derived from the load balancing table, and a server indicated by connection information of the target load balancing information may be derived as the target server. The connection information of the load balancing information may represent a local IP address and a port number of the server.

In addition, for example, the inference task request message may include AI model information representing a specific AI model name and supported hardware information representing specific hardware, and target load balancing information including AI model information representing the specific AI model name and supported hardware information representing the specific hardware may be derived from the load balancing table, and a server indicated by connection information of the target load balancing information may be derived as the target server. The connection information of the load balancing information may represent a local IP address and a port number of the server.

In addition, for example, the inference task request message may include AI model information representing a specific AI model name and a specific version of the specific AI model and supported hardware information representing specific hardware, and target load balancing information including AI model information representing the specific AI model name and the specific version and supported hardware information representing the specific hardware may be derived from the load balancing table, and a server indicated by connection information of the load balancing information may be derived as the target server. The connection information of the target load balancing information may represent a local IP address and a port number of the server.

In addition, for example, the inference task request message may include connection information representing a specific endpoint, and target load balancing information including connection information representing the specific endpoint may be derived from the load balancing table, and a server indicated by the connection information of the target load balancing information may be derived as the target server. The connection information of the load balancing information may indicate a local IP address and a port number of the server.

In addition, for example, the inference task request message may include connection information representing a specific endpoint and AI model information representing a specific AI model name, and target load balancing information including connection information representing the specific endpoint and AI model information representing the specific AI model name may be derived from the load balancing table, and a server indicated by the connection information of the target load balancing information may be derived as the target server. The connection information of the load balancing information may represent a local IP address and a port number of the server.

In addition, for example, the inference task request message may include connection information representing a specific endpoint and AI model information representing a specific AI model name and a specific version of the specific AI model, and target load balancing information including the connection information representing the specific endpoint, and AI model information representing the specific AI model name and the specific version of the specific AI model may be derived from the load balancing table, and a server indicated by the connection information of the target load balancing information may be derived as the target server. The connection information of the load balancing information may represent a local IP address and a port number of the server.

In addition, for example, the inference task request message may include connection information representing a specific endpoint and supported hardware information representing specific hardware, and target load balancing information including connection information representing the specific endpoint and supported hardware information representing the specific hardware may be derived from the load balancing table, and a server indicated by the connection information of the target load balancing information may be derived as the target server. The connection information of the load balancing information may represent a local IP address and a port number of the server.

In addition, for example, the inference task request message may include connection information representing a specific endpoint, AI model information representing a specific AI model name, and supported hardware information representing specific hardware, and target load balancing information including connection information representing the specific endpoint, AI model information representing the specific AI model name, and supported hardware information representing the specific hardware may be derived from the load balancing table, and a server indicated by the connection information of the target load balancing information may be derived as the target server. The connection information of the load balancing information may indicate a local IP address and a port number of the server.

In addition, for example, the inference task request message may include connection information representing a specific endpoint, AI model information representing a specific AI model name and a specific version of the specific AI model, and supported hardware information representing specific hardware, and target load balancing information including connection information representing the specific endpoint, AI model information representing the specific AI model name and the specific version, and supported hardware information representing the specific hardware may be derived from the load balancing table, and a server indicated by the connection information of the target load balancing information may be derived as the target server. The connection information of the load balancing information may indicate a local IP address and a port number of the server.

The load balancing device may derive at least one target server among the servers as in the embodiment, and perform load balancing for the inference task of the AI service on the derived target server. For example, the load balancing device may perform load balancing for the inference task of the AI service on the derived target server based on a preset load balancing algorithm. For example, the preset load balancing algorithm may be a round robin algorithm, a sticky round robin algorithm, a weighted round robin algorithm, an IP/URL hash algorithm, a least connection algorithm, or a least time algorithm.

The target server to which the inference task is distributed through load balancing performs the inference task and transmits an inference task result to the load balancing device (S560). For example, the target server to which the inference task is distributed through load balancing may perform the inference task and transmit the inference task result of the specific inference task to the load balancing device.

The load balancing device transmits the inference task result to a user device (S570). For example, the load balancing device may transmit the inference task result to the user device. Thereafter, the user device may provide a result of the AI service requested by the user to the user based on the inference task result.

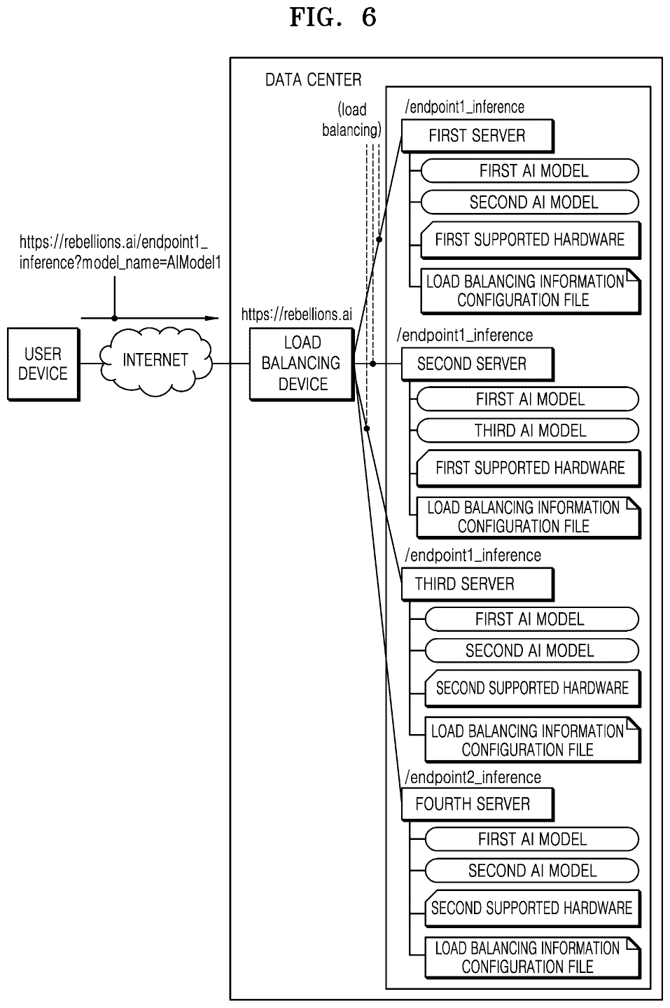

FIG. 6 is a diagram for explaining in detail an embodiment of load balancing an inference task of an AI service using a load balancing table according to the present disclosure.

Referring to FIG. 6, an inference task request message for an AI service may be transmitted from a user device through a network such as the Internet. For example, the inference task request message may be in URL format.

As illustrated in FIG. 6, the inference task request message may be “https://rebellions.ai/endpoint1_inference?model_name=AIModel1”. For example, the inference task request message may include connection information representing a specific endpoint and AI model information representing a specific AI model name, and target load balancing information including connection information representing the specific endpoint and AI model information representing the specific AI model name may be derived from the load balancing table, and a server indicated by the connection information of the target load balancing information may be derived as the target server.

For example, the inference task request message may include connection information representing a first endpoint and AI model information representing a first AI model name. Here, the first endpoint may be “endpoint1_inference” and the first AI model name may be “AIModel1”. Referring to the load balancing table illustrated in Table 2, the first load balancing information, the third load balancing information, and the fifth load balancing information of the load balancing table include connection information representing the first endpoint and AI model information representing the first AI model name. Accordingly, as illustrated in FIG. 6, the first load balancing information, the third load balancing information, and the fifth load balancing information including the connection information representing the first endpoint and the AI model information representing the first AI model name may be derived from the load balancing table, and a first server indicated by the connection information of the first load balancing information, a second server indicated by the connection information of the third load balancing information, and a third server indicated by the connection information of the fifth load balancing information may be derived as target servers.

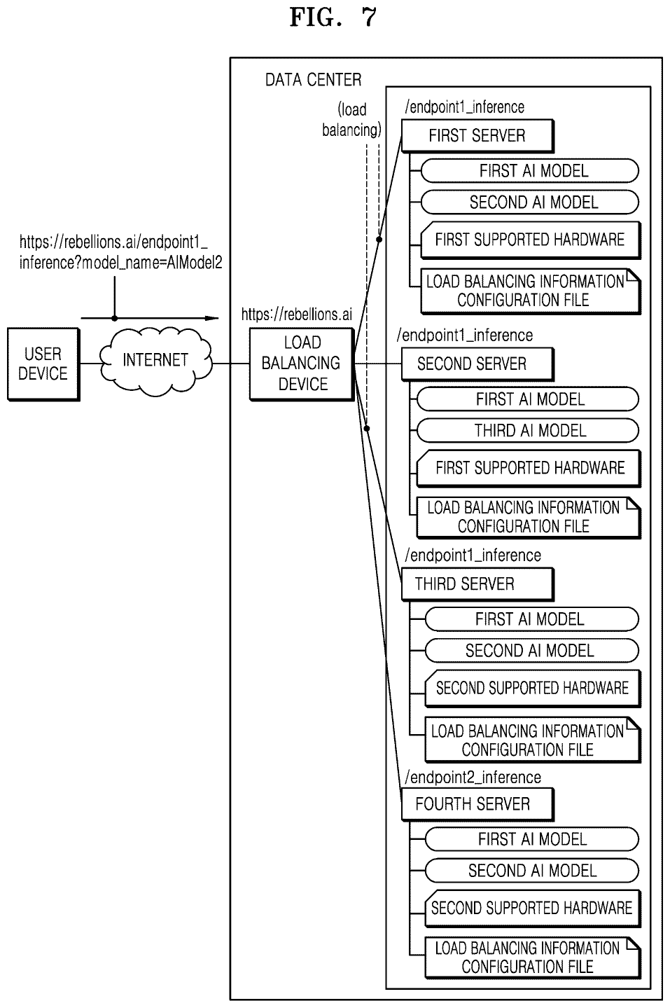

FIG. 7 is a diagram for explaining in detail another embodiment of load balancing an inference task of an AI service using a load balancing table according to the present disclosure.

As illustrated in FIG. 7, the inference task request message may be “https://rebellions.ai/endpoint1_inference?model_name=AIModel2”. The inference task request message may include connection information representing a first endpoint and AI model information representing a second AI model name. Here, the first endpoint may be “endpoint1_inference” and the second AI model name may be “AIModel2”. Referring to the load balancing table illustrated in Table 2, the second load balancing information and the sixth load balancing information of the load balancing table include connection information representing the first endpoint and AI model information representing the second AI model name. Accordingly, as illustrated in FIG. 7, the second load balancing information and the sixth load balancing information including connection information representing the first endpoint and AI model information representing the second AI model name may be derived from the load balancing table, and the first server indicated by the connection information of the second load balancing information and the third server indicated by the connection information of the sixth load balancing information may be derived as target servers.

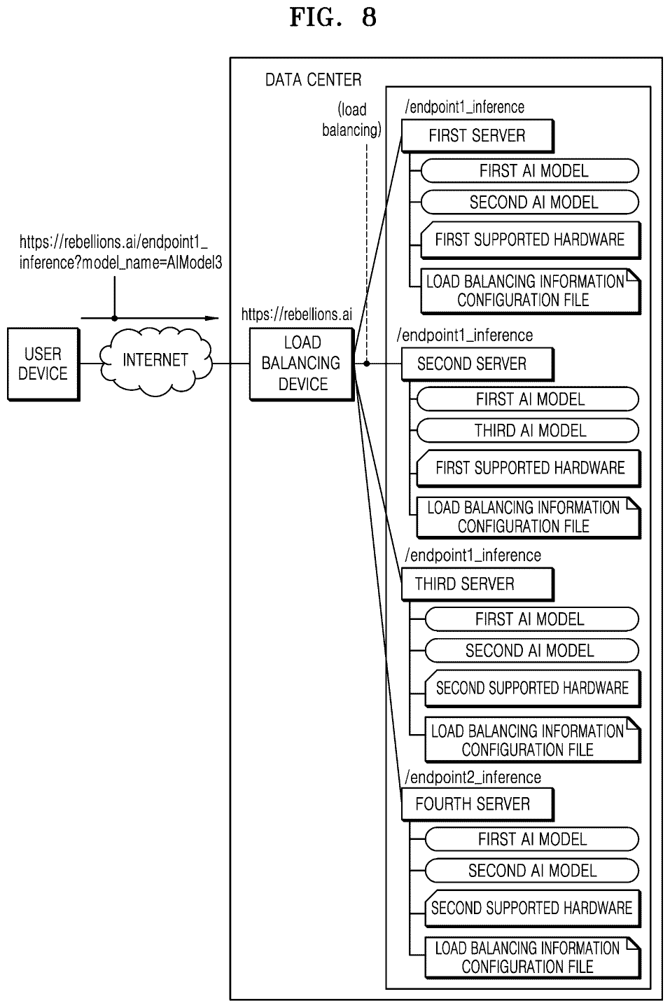

FIG. 8 is a diagram for explaining in detail another embodiment of load balancing an inference task of an AI service using a load balancing table according to the present disclosure.

As illustrated in FIG. 8, the inference task request message may be “https://rebellions.ai/endpoint1_inference?model_name=AIModel3”. The inference task request message may include connection information representing a first endpoint and AI model information representing a third AI model name. Here, the first endpoint may be “endpoint1_inference” and the third AI model name may be “AIModel3”. Referring to the load balancing table illustrated in Table 2, the fourth load balancing information of the load balancing table includes connection information representing the first endpoint and AI model information representing the third AI model name. Therefore, as illustrated in FIG. 8, the fourth load balancing information including the connection information representing the first endpoint and the AI model information representing the third AI model name may be derived from the load balancing table, and the second server indicated by the connection information of the fourth load balancing information may be derived as the target server.

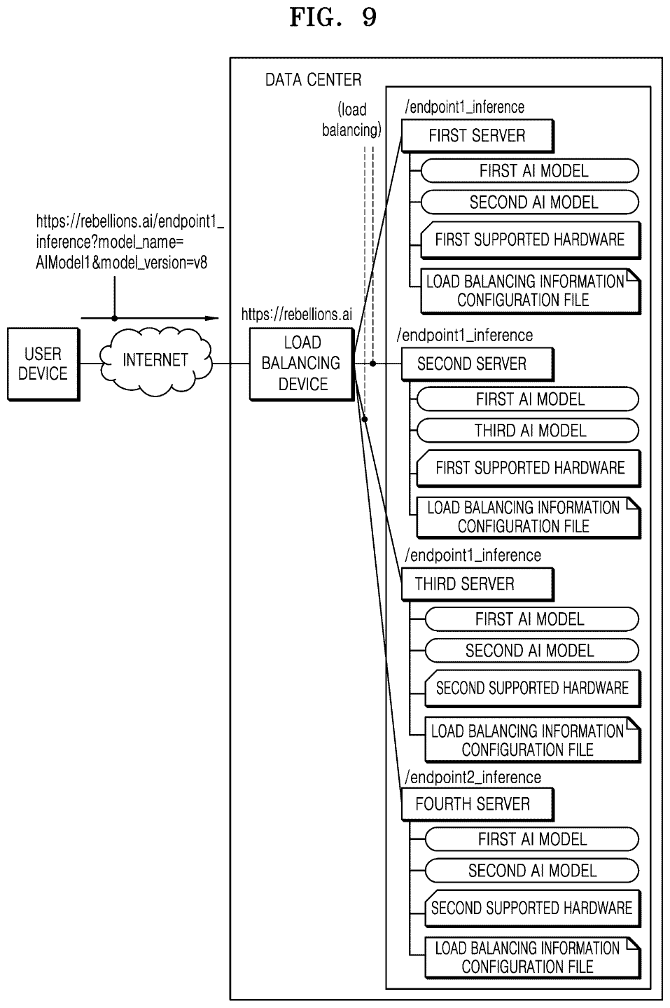

FIG. 9 is a diagram for explaining in detail another embodiment of load balancing an inference task of an AI service using a load balancing table according to the present disclosure.

Referring to FIG. 9, an inference task request message for an AI service may be transmitted from a user device through a network such as the Internet. For example, the inference task request message may be in URL format.

As illustrated in FIG. 9, the inference task request message may be “https://rebellions.ai/endpoint1_inference?model_name=AIModel1&model_version=v8”. For example, the inference task request message may include connection information representing a specific endpoint, and AI model information representing a specific AI model name and a specific AI model version, and target load balancing information including the connection information representing the specific endpoint, and AI model information representing the specific AI model name and a specific AI model version may be derived from the load balancing table, and a server indicated by the connection information of the target load balancing information may be derived as the target server.

For example, the inference task request message may include connection information representing a first endpoint and AI model information representing a first AI model name and a first AI model version. Here, the first endpoint may be “endpoint1_inference”, the first AI model name may be “AIModel1”, and the first AI model version may be “v8”. Referring to the load balancing table illustrated in Table 2, the first load balancing information and the fifth load balancing information of the load balancing table include connection information representing the first endpoint and AI model information representing the first AI model name and the first AI model version. Accordingly, as illustrated in FIG. 9, the first load balancing information and the fifth load balancing information including the connection information representing the first endpoint and the AI model information representing the first AI model name and the first AI model version may be derived from the load balancing table, and the first server indicated by the connection information of the first load balancing information and the third server indicated by the connection information of the fifth load balancing information may be derived as target servers.

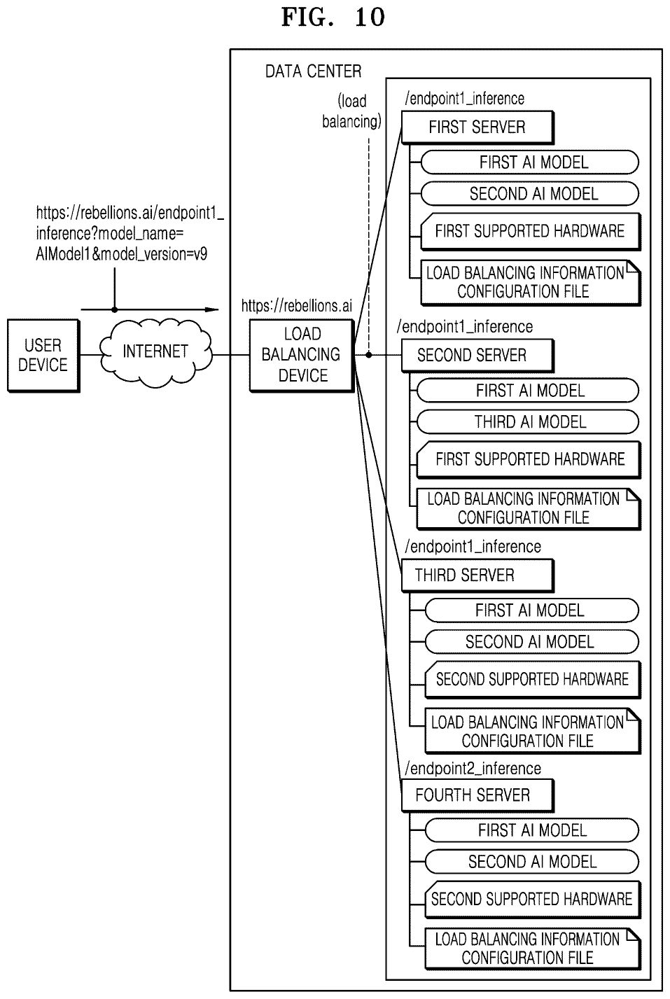

FIG. 10 is a diagram for explaining in detail another embodiment of load balancing an inference task of an AI service using a load balancing table according to the present disclosure.

As illustrated in FIG. 10, the inference task request message may be “https://rebellions.ai/endpoint1_inference?model_name=AIModel1&model_version=v9”. The inference task request message may include connection information representing a first endpoint and AI model information representing a first AI model name and a second AI model version. Here, the first endpoint may be “endpoint1_inference”, the first AI model name may be “AIModel1”, and the second AI model version may be “v9”. Referring to the load balancing table illustrated in Table 2, the third load balancing information of the load balancing table includes connection information representing the first endpoint and AI model information representing the first AI model name and the second AI model version. Accordingly, as illustrated in FIG. 10, the third load balancing information including connection information representing the first endpoint and AI model information representing the first AI model name and the second AI model version may be derived from the load balancing table, and the second server indicated by the connection information of the third load balancing information may be derived as the target server.

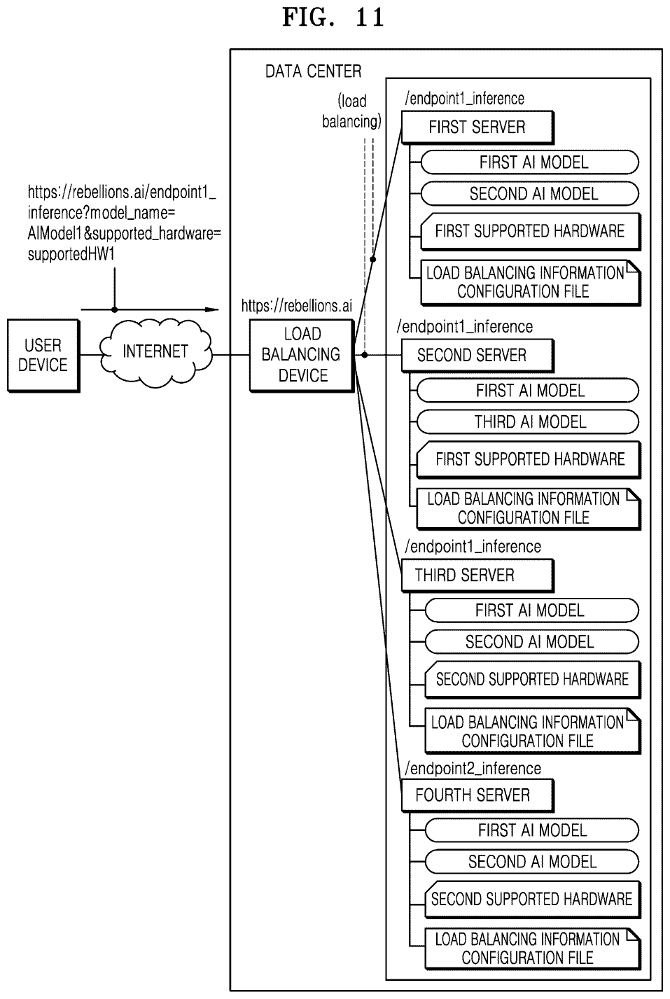

FIG. 11 is a diagram for explaining in detail another embodiment of load balancing an inference task of an AI service using a load balancing table according to the present disclosure.

Referring to FIG. 11, an inference task request message for an AI service may be transmitted from a user device through a network such as the Internet. For example, the inference task request message may be in URL format.

As illustrated in FIG. 11, the inference task request message may be “https://rebellions.ai/endpoint1_inference?model_name=AIModel1&supported_hardware=supportedHW1”. For example, the inference task request message may include connection information representing a specific endpoint, AI model information representing a specific AI model name, and supported hardware information representing specific supported hardware, and target load balancing information including the connection information representing the specific endpoint, the AI model information representing the specific AI model name, and the supported hardware information representing the specific supported hardware may be derived from the load balancing table, and a server indicated by the connection information of the target load balancing information may be derived as the target server.

For example, the inference task request message may include connection information representing a first endpoint, AI model information representing a first AI model name, and supported hardware information representing a first supported hardware. Here, the first endpoint may be “endpoint1_inference”, the first AI model name may be “AIModel1”, and the first supported hardware may be “supportedHW1”. Referring to the load balancing table illustrated in Table 2, the first load balancing information and the third load balancing information of the load balancing table include connection information representing the first endpoint, AI model information representing the first AI model name, and supported hardware information representing the first supported hardware. Accordingly, as illustrated in FIG. 11, the first load balancing information and the third load balancing information including connection information representing the first endpoint, AI model information representing the first AI model name, and supported hardware information representing the first supported hardware may be derived from the load balancing table, and the first server indicated by the connection information of the first load balancing information and the second server indicated by the connection information of the third load balancing information may be derived as target servers.

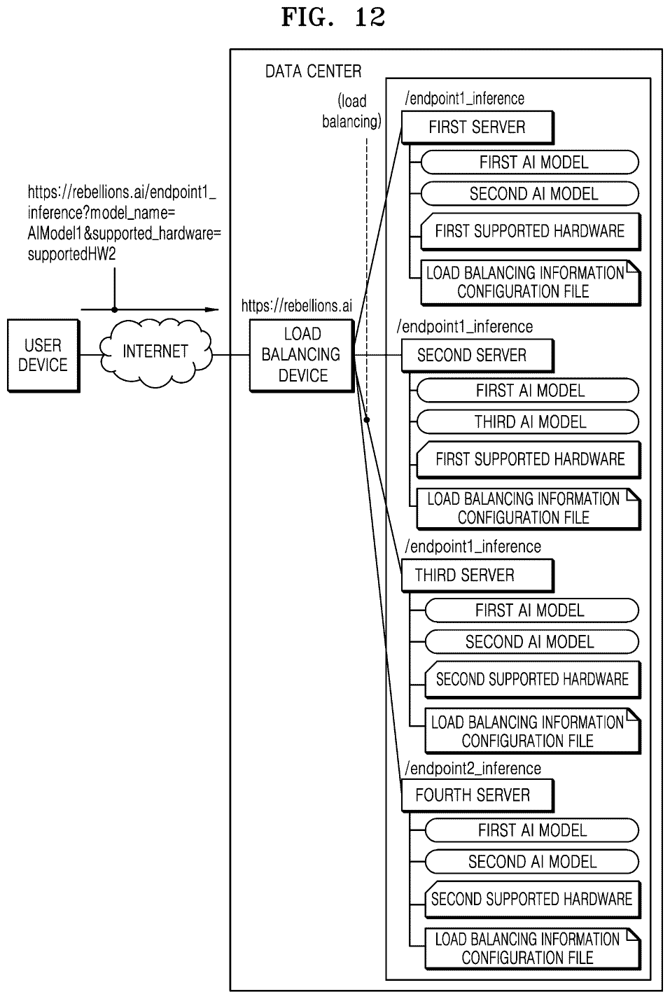

FIG. 12 is a diagram for explaining in detail another embodiment of load balancing an inference task of an AI service using a load balancing table according to the present disclosure.

As illustrated in FIG. 12, the inference task request message may be “https://rebellions.ai/endpoint1_inference?model_name=AIModel1&supported_hardware=supportedHW2”. The inference task request message may include connection information representing a first endpoint, AI model information representing a first AI model name, and supported hardware information representing a second supported hardware. Here, the first endpoint may be “endpoint1_inference”, the first AI model name may be “AIModel1”, and the first supported hardware may be “supportedHW2”. Referring to the load balancing table illustrated in Table 2, the fifth load balancing information of the load balancing table includes connection information representing the first endpoint, AI model information representing the first AI model name, and supported hardware information representing the second supported hardware. Accordingly, as illustrated in FIG. 12, the fifth load balancing information including connection information representing the first endpoint, AI model information representing the first AI model name, and supported hardware information representing the second supported hardware may be derived from the load balancing table, and the third server indicated by the connection information of the fifth load balancing information may be derived as a target server.

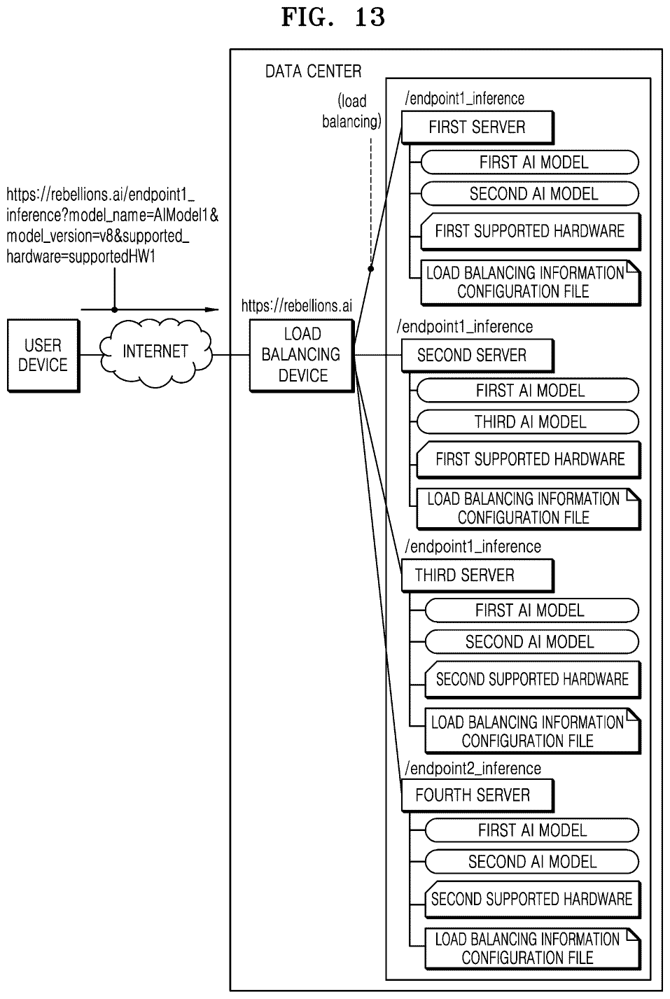

FIG. 13 is a diagram for explaining in detail another embodiment of load balancing an inference task of an AI service using a load balancing table according to the present disclosure.

Referring to FIG. 13, an inference task request message for an AI service may be transmitted from a user device through a network such as the Internet. For example, the inference task request message may be in URL format.

As illustrated in FIG. 13, the inference task request message may be “https://rebellions.ai/endpoint1_inference?model_name=AIModel1&model_version=v8&supported_hard ware=supportedHW1”. For example, the inference task request message may include connection information representing a specific endpoint, AI model information representing a specific AI model name and a specific AI model version, and supported hardware information representing specific supported hardware, and target load balancing information including connection information representing the specific endpoint, AI model information representing the specific AI model name and the specific AI model version, and supported hardware information representing the specific supported hardware may be derived from the load balancing table, and a server indicated by the connection information of the target load balancing information may be derived as the target server.

For example, the inference task request message may include connection information representing a first endpoint, AI model information representing a first AI model name and a first AI model version, and supported hardware information representing a first supported hardware. Here, the first endpoint may be “endpoint1_inference”, the first AI model name may be “AIModel1”, the first AI model version may be “v8”, and the first supported hardware may be “supportedHW1”. Referring to the load balancing table illustrated in Table 2, the first load balancing information of the load balancing table includes connection information representing the first endpoint, AI model information representing the first AI model name and the first AI model version, and supported hardware information representing the first supported hardware. Accordingly, as illustrated in FIG. 13, the first load balancing information including connection information representing the first endpoint, AI model information representing the first AI model name and the first AI model version, and supported hardware information representing the first supported hardware may be derived from the load balancing table, and the first server indicated by the connection information of the first load balancing information may be derived as the target server.

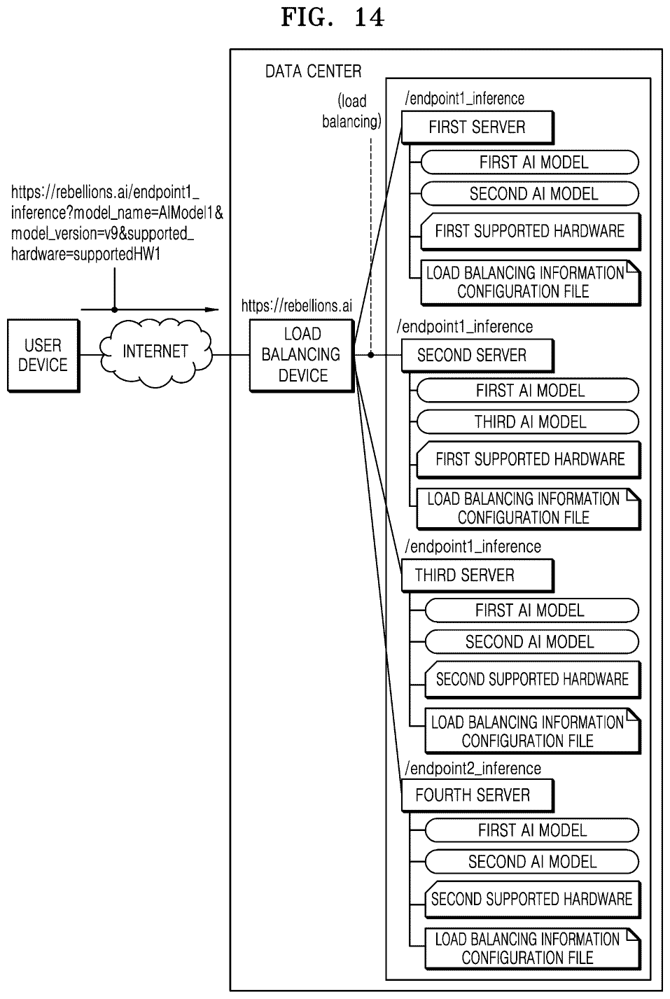

FIG. 14 is a diagram for explaining in detail another embodiment of load balancing an inference task of an AI service using a load balancing table according to the present disclosure.

As illustrated in FIG. 14, the inference task request message may be “https://rebellions.ai/endpoint1_inference?model_name=AIModel1&model_version=v9&supported_hard ware-supportedHW1”. The inference task request message may include connection information representing a first endpoint, AI model information representing a first AI model name and a second AI model version, and supported hardware information representing a first supported hardware. Here, the first endpoint may be “endpoint1_inference”, the first AI model name may be “AIModel1”, the second AI model version may be “v9”, and the first supported hardware may be “supportedHW1”. Referring to the load balancing table illustrated in Table 2, the third load balancing information of the load balancing table includes connection information representing the first endpoint, AI model information representing the first AI model name and the second AI model version, and supported hardware information representing the first supported hardware. Accordingly, as illustrated in FIG. 14, the third load balancing information including connection information representing the first endpoint, AI model information representing the first AI model name and the second AI model version, and supported hardware information representing the first supported hardware may be derived from the load balancing table, and the second server indicated by the connection information of the third load balancing information may be derived as the target server.

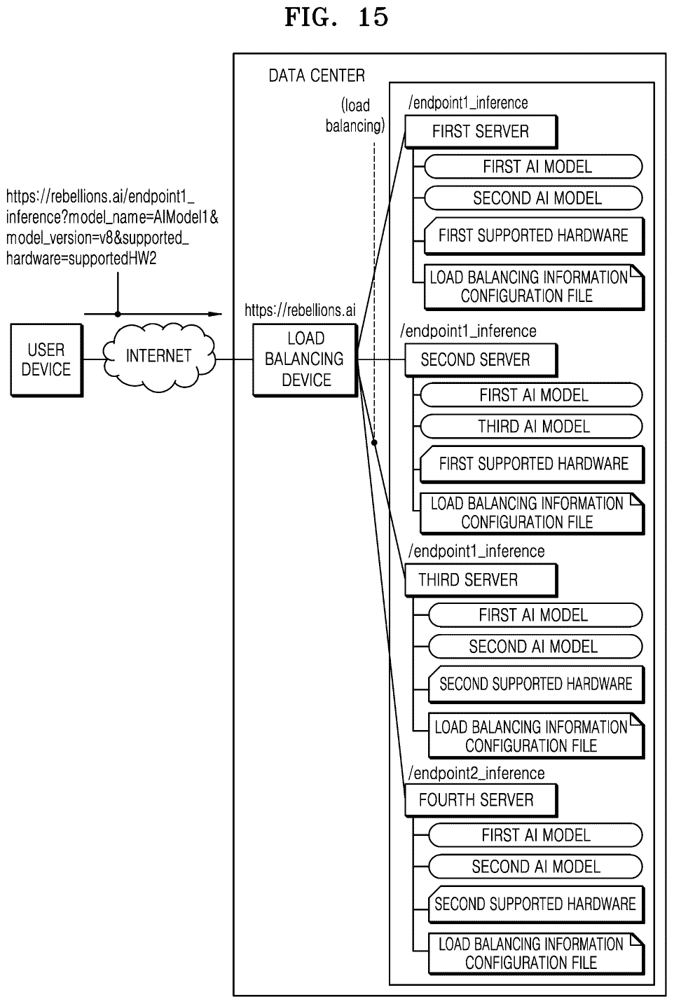

FIG. 15 is a diagram for explaining in detail another embodiment of load balancing an inference task of an AI service using a load balancing table according to the present disclosure.

As illustrated in FIG. 15, the inference task request message may be “https://rebellions.ai/endpoint1_inference?model_name=AIModel1&model_version=v8&supported_hard ware=supportedHW2”. The inference task request message may include connection information representing a first endpoint, AI model information representing a first AI model name and a first AI model version, and supported hardware information representing a second supported hardware. Here, the first endpoint may be “endpoint1_inference”, the first AI model name may be “AIModel1”, the first AI model version may be “v8”, and the second supported hardware may be “supportedHW2”. Referring to the load balancing table illustrated in Table 2, the fifth load balancing information of the load balancing table includes connection information representing the first endpoint, AI model information representing the first AI model name and the first AI model version, and supported hardware information representing the second supported hardware. Accordingly, as illustrated in FIG. 15, the fifth load balancing information including connection information representing the first endpoint, AI model information representing the first AI model name and the first AI model version, and supported hardware information representing the second supported hardware may be derived from the load balancing table, and the third server indicated by the connection information of the fifth load balancing information may be derived as a target server.

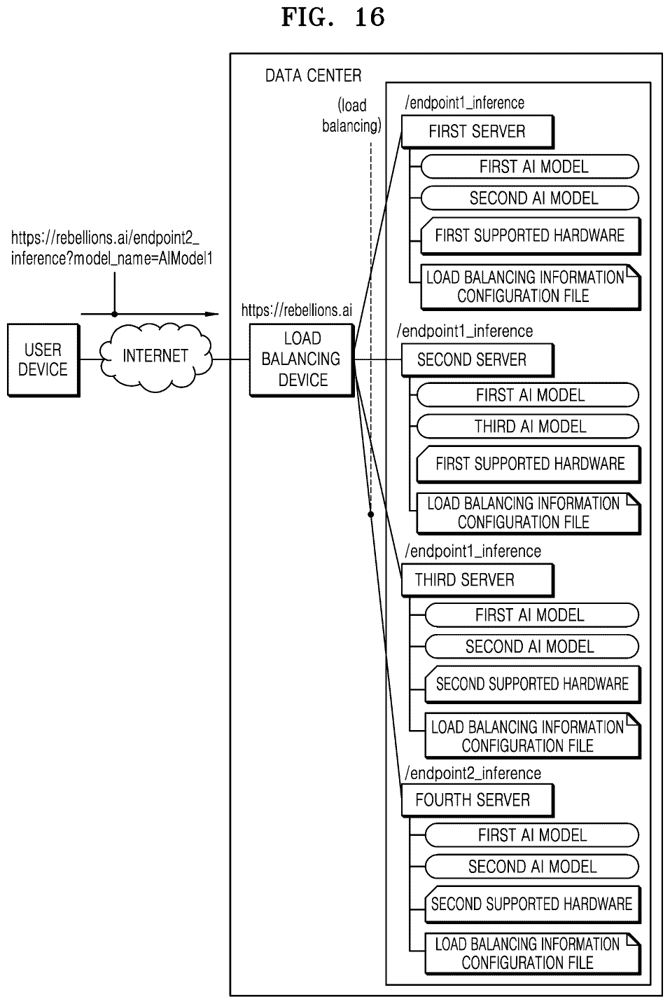

FIG. 16 is a diagram for explaining in detail another embodiment of load balancing an inference task of an AI service using a load balancing table according to the present disclosure.

Referring to FIG. 16, an inference task request message for an AI service may be transmitted from a user device through a network such as the Internet. For example, the inference task request message may be in URL format.

As illustrated in FIG. 16, the inference task request message may be “https://rebellions.ai/endpoint2_inference?model_name=AIModel1”. The inference task request message may include connection information representing a second endpoint and AI model information representing a first AI model name. Here, the second endpoint may be “endpoint2_inference” and the first AI model name may be “AIModel1”. Referring to the load balancing table illustrated in Table 2, the seventh load balancing information of the load balancing table includes connection information representing the second endpoint and AI model information representing the first AI model name. Therefore, as illustrated in FIG. 16, the seventh load balancing information including the connection information representing the second endpoint and the AI model information representing the first AI model name may be derived from the load balancing table, and the fourth server indicated by the connection information of the seventh load balancing information may be derived as the target server.

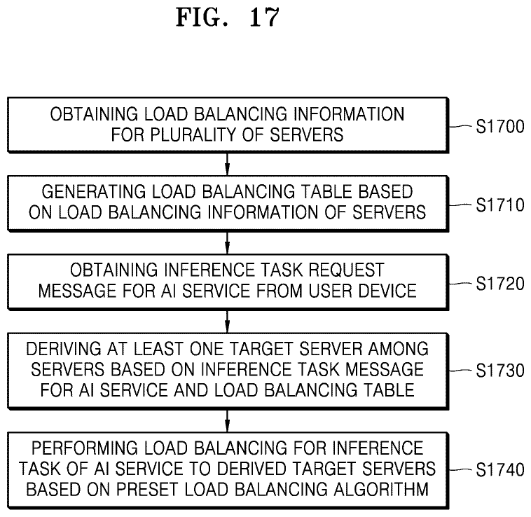

FIG. 17 is a flowchart for explaining in detail a load balancing method using a load balancing table in an AI service providing system according to an embodiment of the present disclosure.

The load balancing device obtains load balancing information of a plurality of servers (S1700). A data center providing AI services may include a load balancing device and a plurality of servers. The plurality of servers may support AI models providing various AI services and may include various supported hardware. The supported hardware may include various types of AI accelerators from various manufacturers. The load balancing device may obtain load balancing information from the plurality of servers. For example, each server of the plurality of servers in the data center may generate load balancing information and transmit the load balancing information to the load balancing device. For example, the load balancing information may be generated in a form of a load balancing information configuration file.

For example, the load balancing information may include connection information, AI model information, and/or supported hardware information of each server. For example, the connection information of each server may represent a local IP address, a port number, and/or an endpoint of each server. In addition, for example, the AI model information of each server may represent an AI model name and/or an AI model version supported by each server. In addition, for example, the supported hardware information of each server may represent supported hardware of each server.

Meanwhile, for example, each server of the plurality of servers may transmit the load balancing information to the load balancing device at specific time intervals. The load balancing device may update a load balancing table based on the load balancing information transmitted at specific time intervals. That is, the load balancing information of each server may be periodically transmitted to the load balancing device, and through this, the load balancing device may automatically check for changes in the load balancing information of each server.

The load balancing device generates a load balancing table based on the load balancing information of the servers (S1710).

For example, the load balancing device may generate an initial load balancing table. The load balancing device may register service information representing a service IP address, a service port number, and/or a base URL in the initial load balancing table. That is, the initial load balancing table may include load balancing information for an inference task of an AI service, and the load balancing information may include service information.

Thereafter, the load balancing device may generate the load balancing table by updating the initial load balancing table based on the load balancing information of the servers. That is, the load balancing device may generate the load balancing table by updating load balancing information of the initial balancing table based on the load balancing information of the servers. For example, the load balancing table may include load balancing information for an inference task of an AI service. The load balancing information included in the load balancing table may include service information, connection information supported by a server, AI model information supported by a server, and supported hardware information of a server.

Meanwhile, for example, the load balancing information may be transmitted from the plurality of servers at specific time intervals, and the load balancing table may be updated based on the load balancing information transmitted at the specific time intervals.

The load balancing device obtains an inference task request message for an AI service from a user device (S1720).

The user device may be connected to the data center via a network. For example, the user device may be connected to the load balancing device of the data center via a network. For example, the load balancing device may obtain an inference task request message for an inference task of the AI service from a user device through a network. “network” may be implemented as a wired network such as a Local Area Network (LAN), a Wide Area Network (WAN), or a Value Added Network (VAN), or any type of wireless network such as a mobile radio communication network or a satellite communication network.

The load balancing device derives at least one target server among the servers based on the inference task message for the AI service and the load balancing table (S1730).

The load balancing device may derive target load balancing information including the same information as information included in the inference task request message from the load balancing table, and derive a server indicated by the connection information of the derived target load balancing information as the target server. The connection information of the load balancing information may represent a local IP address and a port number of the server.

For example, when the inference task message includes AI model information representing a specific AI model name, target load balancing information including the AI model information representing the specific AI model name may be derived from the load balancing table, and a server indicated by connection information of the derived target load balancing information may be derived as the target server.

In addition, for example, when the inference task message includes AI model information representing a specific AI model name and a specific AI model version, target load balancing information including the AI model information representing the specific AI model name and the specific AI model version may be derived from the load balancing table, and a server indicated by connection information of the derived target load balancing information may be derived as the target server.

In addition, for example, when the inference task message includes AI model information representing a specific AI model name and supported hardware information representing specific supported hardware, target load balancing information including the AI model information representing the specific AI model name and the supported hardware information representing the specific supported hardware may be derived from the load balancing table, and a server indicated by connection information of the derived target load balancing information may be derived as the target server.

In addition, for example, when the inference task message includes AI model information representing a specific AI model name and a specific AI model version and supported hardware information representing specific supported hardware, target load balancing information including the AI model information representing the specific AI model name and the specific AI model version and the supported hardware information representing the specific supported hardware may be derived from the load balancing table, and a server indicated by connection information of the derived target load balancing information may be derived as the target server.

In addition, for example, when the inference task message includes connection information representing a specific endpoint, target load balancing information including the connection information representing the specific endpoint may be derived from the load balancing table, and a server indicated by the connection information of the derived target load balancing information may be derived as the target server.

In addition, for example, when the inference task message includes connection information representing a specific endpoint and AI model information representing a specific AI model name, target load balancing information including the connection information representing the specific endpoint and the AI model information representing the specific AI model name may be derived from the load balancing table, and a server indicated by the connection information of the derived target load balancing information may be derived as the target server.

In addition, for example, when the inference task message includes connection information representing a specific endpoint, and AI model information representing a specific AI model name and a specific AI model version, target load balancing information including the connection information representing the specific endpoint and the AI model information representing the specific AI model name and the specific AI model version may be derived from the load balancing table, and a server indicated by the connection information of the derived target load balancing information may be derived as the target server.

In addition, for example, when the inference task message includes connection information representing a specific endpoint, AI model information representing a specific AI model name, and supported hardware information representing specific supported hardware, target load balancing information including the connection information representing the specific endpoint, the AI model information representing the specific AI model name, and the supported hardware information representing the specific supported hardware may be derived from the load balancing table, and a server indicated by the connection information of the derived target load balancing information may be derived as the target server.

In addition, for example, when the inference task message includes connection information representing a specific endpoint, AI model information representing a specific AI model name and a specific AI model version, and supported hardware information representing specific supported hardware, target load balancing information including the connection information representing the specific endpoint, the AI model information representing the specific AI model name and the specific AI model version, and the supported hardware information representing the specific supported hardware may be derived from the load balancing table, and a server indicated by the connection information of the derived target load balancing information may be derived as the target server.

The load balancing device performs load balancing for an inference task of the AI service to the derived target servers based on a preset load balancing algorithm (S1740).

The load balancing device may distribute an inference task of the AI service to the derived target servers according to a preset load balancing algorithm. For example, the preset load balancing algorithm may be a round robin algorithm, a sticky round robin algorithm, a weighted round robin algorithm, an IP/URL hash algorithm, a least connection algorithm, or a least time algorithm.

Meanwhile, for example, the load balancing information may be transmitted from the plurality of servers at specific time intervals, and the load balancing table may be updated based on the load balancing information transmitted at the specific time intervals. For example, when a specific inference task request message for a specific AI service is obtained after the load balancing table is updated, at least one target server among the plurality of servers may be derived based on the updated load balancing table, and load balancing for an inference task of the specific AI service may be performed on the derived target server.

The target server to which the inference task is distributed may perform the inference task of the AI service and transmit a result of the inference task to the load balancing device.

The load balancing device may transmit the result of the inference task transmitted from the target server to which the inference task is distributed to the user device. Thereafter, the user device may provide a result of the AI service requested by the user to the user based on the result of the inference task.

The load balancing method in the AI service providing system according to embodiments described above may perform load balancing of AI service inference tasks for multiple servers supporting various AI models and including various supported hardware by considering supported AI models and/or supported hardware, thereby improving the efficiency of the load balancing task and reducing management complexity.

In addition, a load balancing table including information about AI models, AI model versions, supported hardware and endpoints supported by multiple servers may be generated, and load balancing considering the supported AI models and/or supported hardware may be performed based on the generated load balancing table, thereby improving the efficiency of load balancing tasks and reducing its complexity.

In addition, load balancing information may be periodically received from servers and a load balancing table used for load balancing may be automatically updated, thereby reducing management complexity of servers in a complex data center.

Although the present disclosure described above has been described with reference to the embodiments illustrated in the drawings, these are merely exemplary, and those skilled in the art will understand that various modifications and variations of the embodiments are possible. That is, the scope of the present disclosure is not limited to the above-described embodiments, and various modifications and improvements made by those skilled in the art using the basic concept of the embodiments defined in the following claims also included in the scope of the embodiments. Therefore, the scope of the present disclosure is defined by the technical spirit of the appended claims.

1. A load balancing method in an Artificial Intelligence (AI) service providing system, comprising:
receiving load balancing information from a plurality of servers, wherein the load balancing information received from a respective one server of the plurality of servers comprises connection information of the respective one server, information of one or more AI models supported by the respective one server, and information of hardware supporting the one or more AI models;
generating a load balancing table based on the load balancing information of the plurality of servers, wherein the load balancing table is used for load balancing between the plurality of servers and comprises connection information of the plurality of servers, information of AI models supported by the plurality of servers, and information of hardware supporting the AI models supported by the plurality of servers;
obtaining an inference task request message for an AI service from a user device;
deriving at least one target server among the plurality of servers based on the inference task request message for the AI service and the load balancing table; and
performing load balancing for an inference task of the AI service on the derived target server based on a preset load balancing algorithm,
wherein the deriving at least one target server among the plurality of servers based on the inference task request message for the AI service and the load balancing table comprises:
deriving target load balancing information including same information as information included in the inference task request message from the load balancing table; and
deriving a server indicated by connection information of the derived target load balancing information as the target server.

2. (canceled)

3. The method of claim 1, wherein when the inference task request message includes AI model information representing a specific AI model name, target load balancing information including the AI model information representing the specific AI model name is derived from the load balancing table, and a server indicated by connection information of the derived target load balancing information is derived as the target server.

4. The method of claim 1, wherein when the inference task request message includes AI model information representing a specific AI model name and a specific AI model version, target load balancing information including the AI model information representing the specific AI model name and the specific AI model version is derived from the load balancing table, and a server indicated by connection information of the derived target load balancing information is derived as the target server.

5. The method of claim 1, wherein when the inference task request message includes AI model information representing a specific AI model name and a specific AI model version and supported hardware information representing specific supported hardware, target load balancing information including the AI model information representing the specific AI model name and the specific AI model version and the supported hardware information representing the specific supported hardware is derived from the load balancing table, and a server indicated by connection information of the derived target load balancing information is derived as the target server.

6. The method of claim 1, wherein when the inference task request message includes connection information representing a specific endpoint, target load balancing information including the connection information representing the specific endpoint is derived from the load balancing table, and a server indicated by the connection information of the derived target load balancing information is derived as the target server.

7. The method of claim 1, wherein when the inference task request message includes connection information representing a specific endpoint, AI model information representing a specific AI model name and a specific AI model version, and supported hardware information representing specific supported hardware, target load balancing information including the connection information representing the specific endpoint, the AI model information representing the specific AI model name and the specific AI model version, and the supported hardware information representing the specific supported hardware is derived from the load balancing table, and a server indicated by the connection information of the derived target load balancing information is derived as the target server.

8. The method of claim 1, wherein the load balancing information is transmitted from the plurality of servers at specific time intervals, and the load balancing table is updated based on the load balancing information transmitted at the specific time intervals, and
wherein when a specific inference task request message for a specific AI service is obtained after the load balancing table is updated, at least one target server among the plurality of servers is derived based on the updated load balancing table, and load balancing for an inference task of the specific AI service is performed on the derived target server.

9. The method of claim 1, wherein load balancing information included in the load balancing table includes service information, connection information supported by a server, AI model information supported by a server, and supported hardware information of a server.

10. The method of claim 1, wherein the preset load balancing algorithm is a round robin algorithm, a sticky round robin algorithm, a weighted round robin algorithm, an IP/URL hash algorithm, a least connection algorithm, or a least time algorithm.

11. An Artificial Intelligence (AI) service providing system, comprising:
a data center including a load balancing device and a plurality of servers; and
a user device connected to the data center via a network,
wherein the plurality of servers generates load balancing information and transmits the load balancing information to the load balancing device, wherein the load balancing information for a respective one server of the plurality of servers comprises connection information of the respective one server, information of one or more AI models supported by the respective one server, and information of hardware supporting the one or more AI models,
wherein the load balancing device generates a load balancing table based on the load balancing information, wherein the load balancing table is used for load balancing between the plurality of servers and comprises connection information of the plurality of servers, information of AI models supported by the plurality of servers, and information of hardware supporting the AI models supported by the plurality of servers, wherein the load balancing device obtains an inference task request message for an AI service from the user device, derives at least one target server among the plurality of servers based on the inference task request message for the AI service and the load balancing table, performs load balancing for an inference task of the AI service on the derived target server based on a preset load balancing algorithm, and transmits a result of the inference task transmitted from a target server to which the inference task is distributed to the user device, and
wherein the load balancing device derives target load balancing information including same information as information included in the inference task request message from the load balancing table, and wherein the load balancing device derives a server indicated by connection information of the derived target load balancing information as the target server.

12. (canceled)

13. The system of claim 11, wherein when the inference task request message includes AI model information representing a specific AI model name, target load balancing information including the AI model information representing the specific AI model name is derived from the load balancing table, and a server indicated by connection information of the derived target load balancing information is derived as the target server.

14. The system of claim 11, wherein when the inference task request message includes AI model information representing a specific AI model name and a specific AI model version, target load balancing information including the AI model information representing the specific AI model name and the specific AI model version is derived from the load balancing table, and a server indicated by connection information of the derived target load balancing information is derived as the target server.

15. The system of claim 11, wherein when the inference task request message includes AI model information representing a specific AI model name and a specific AI model version and supported hardware information representing specific supported hardware, target load balancing information including the AI model information representing the specific AI model name and the specific AI model version and the supported hardware information representing the specific supported hardware is derived from the load balancing table, and a server indicated by connection information of the derived target load balancing information is derived as the target server.

16. The system of claim 11, wherein when the inference task request message includes connection information representing a specific endpoint, target load balancing information including the connection information representing the specific endpoint is derived from the load balancing table, and a server indicated by the connection information of the derived target load balancing information is derived as the target server.

17. The system of claim 11, wherein when the inference task request message includes connection information representing a specific endpoint, AI model information representing a specific AI model name and a specific AI model version, and supported hardware information representing specific supported hardware, target load balancing information including the connection information representing the specific endpoint, the AI model information representing the specific AI model name and the specific AI model version, and the supported hardware information representing the specific supported hardware is derived from the load balancing table, and a server indicated by the connection information of the derived target load balancing information is derived as the target server.

18. The system of claim 11, wherein the load balancing information is transmitted from the plurality of servers at specific time intervals, and the load balancing table is updated based on the load balancing information transmitted at the specific time intervals, and
wherein when a specific inference task request message for a specific AI service is obtained after the load balancing table is updated, at least one target server among the plurality of servers is derived based on the updated load balancing table, and load balancing for an inference task of the specific AI service is performed on the derived target server.

19. The system of claim 11, wherein load balancing information included in the load balancing table includes service information, connection information supported by a server, AI model information supported by a server, and supported hardware information of a server.

20. The system of claim 11, wherein the preset load balancing algorithm is a round robin algorithm, a sticky round robin algorithm, a weighted round robin algorithm, an IP/URL hash algorithm, a least connection algorithm, or a least time algorithm.
